(19) United States
(12) Patent Application Publication
(10) Pub. No.: US 2014/0139163 A1
(43) Pub. Date: May 22, 2014

(54) FAN CONTROL CIRCUIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/065,494

(22) Filed: Oct. 29, 2013

(30) Foreign Application Priority Data
Nov. 21, 2012 (CN) 2012104747132

(51) Int. Cl. H02P 1/04

(52) U.S. Cl. CPC H02P 1/04
USPC 318/453

(57) ABSTRACT

The fan control circuit includes a first switch unit, a second switch unit, and a delay unit. The first switch unit outputs a first or a second voltage according to a power good signal. The delay switch unit performs a delay operation on the power good signal, and outputs different control signals to the second switch unit before or after the delay operation exceeds a predetermined time. The second switch unit receives the control signals from the delay unit, and connects or disconnects the first switch unit to or from a fan according to the control signals.

### BACKGROUND

1. Technical Field

The present disclosure relates to a fan control circuit.

2. Description of Related Art

A computer may employ one or more fans to dissipate heat generated by components, such as a north bridge chip, a south bridge chip, or a central processing unit, thereby keeping the operation of the computer normal. However, when the computer shuts down, the fans may stop operating while the components may still be at a high temperature, which may shorten the life of the components.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a fan control circuit of the present disclosure.

FIG. 2 is a circuit diagram of the fan control circuit of FIG. 1.

### DETAILED DESCRIPTION

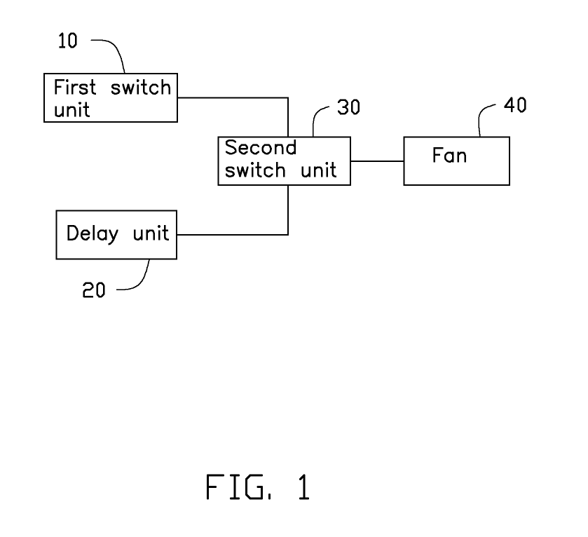

FIG. 1 illustrates an embodiment of a fan control circuit for a fan 40, to dissipate heat of a computer. The fan control circuit includes a first switch unit 10, a delay unit 20, and a second switch unit 30 coupled to the first switch unit 10 and the delay unit 20. The delay unit 20 outputs control signals with respect to a delay time delayed by the delay unit 20 after exceeding a predetermined time. The second switch unit 30 controls connection between the first switch unit 10 and the fan 40 according to the control signals from the delay unit 20.

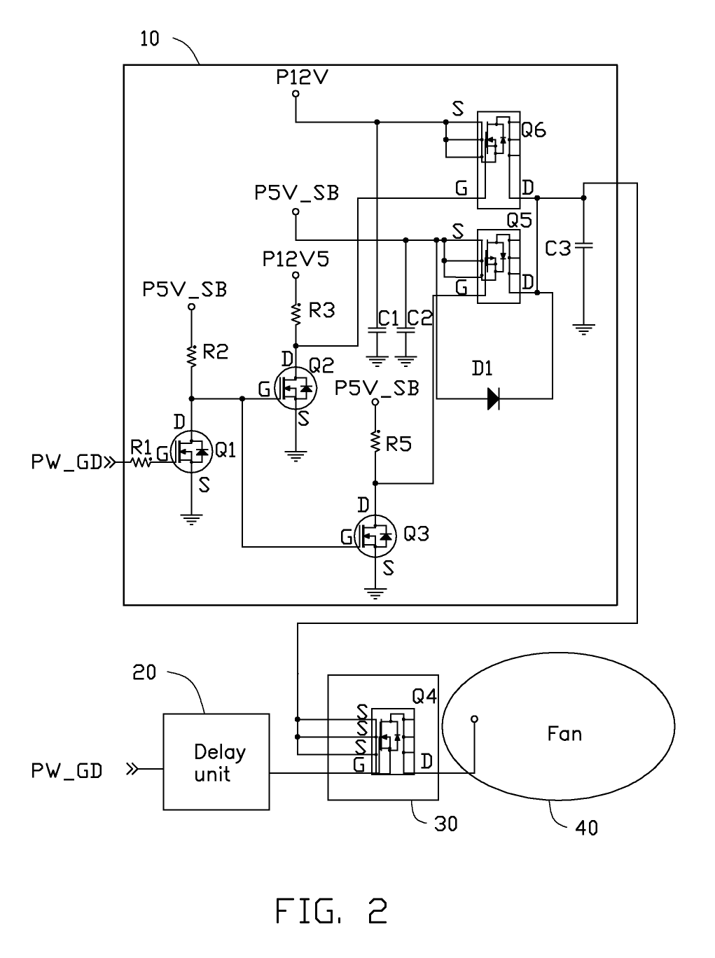

FIG. 2 shows that the first switch unit 10 receives a power good signal (PW_GD) from a power supply unit of the computer, and outputs different voltages to the second switch unit 30 according to the power good signal. The first switch unit 10 includes four resistors R1-R3 and R5, three capacitors C1-C3, and five transistors Q1-Q3, Q5, and Q6, and a diode D1. In the embodiment, the transistors Q1-Q3, and Q6 are n-channel metallic oxide semiconductor field effect transistors (MOSFETs), and the transistor Q5 is a p-channel MOSFET.

A gate G of the transistor Q1 receives the power good signal PW_GD through the resistor R1. A source of the transistor Q1 is connected to ground. A drain of the transistor Q1 is coupled to a standby power terminal P5V_SB through the resistor R2, and is also coupled to gates G of the transistors Q2 and Q3. Sources S of the transistors Q2 and Q3 are connected to ground. A drain D of the transistor Q2 is coupled to a system power terminal P12V5 through the resistor R3, and is also coupled to a gate G of the transistor Q6. A drain D of the transistor Q3 is coupled to the standby power terminal P5V_SB through the resistor R5, and is also coupled to a gate G of the transistor Q5. A source S of the transistor Q5 is coupled to the standby power terminal P5V_SB, and is also connected to ground through the capacitor C2. The source S of the transistor Q5 is coupled to an anode of the diode D1. A cathode of the diode D1 is coupled to a drain D of the transistor Q5. The drain D of the transistor Q5 is coupled to a drain D of the transistor Q6. The drain D of the transistor Q6 is connected to ground through the capacitor C3, and is also coupled to the second switch unit 30. The drain D of the transistor Q6 outputs different voltages to the second switch unit 30. A source S of the transistor Q6 is connected to ground through the capacitor C1, and is also coupled to a system power terminal P12V.

The delay unit 20 receives the power good signal PW_GD, and performs a delay operation on the power good signal PW_GD. The delay unit 20 outputs the control signals after delaying for the predetermined time. For example, when the delay unit 20 receives a high level power good signal PW_GD, such as logic 1, the delay unit 20 outputs a high level control signal after receiving the high level power good signal PW_GD. Similarly, when the delay unit 20 receives a low level power good signal PW_GD, such as a logic 0, the delay unit 20 outputs a low level control signal after receiving the low level power good signal PW_GD.

The second switch unit 30 controls the connection between the first switch unit 10 and the fan 40 according to the control signal from the delay unit 20. The second switch unit 30 includes a transistor Q4. A gate G of the transistor Q4 receives the control signal from the delay unit 20. A source S of the transistor Q4 is coupled to the drain D of the transistor Q6. A drain D of the transistor Q4 is coupled to the fan 40.

During the operation of bootstrapping of the computer, the power good signal PW_GD is at high level. The gate G of the transistor Q1 receives the high level power good signal PW_GD, and the transistor Q1 is turned on. The drain D of the transistor Q1 is at low level. Accordingly, the gates of the transistor Q2 and Q3 are at low level, the transistors Q2 and Q3 are turned off, so that the drains D of the transistor Q2 and Q3 are at high level. In the meanwhile, the gate G of the transistor Q6 is at high level, so the transistor Q6 is turned on. Accordingly, the transistor Q5 is turned off, and the first switch unit 10 outputs the system power terminal P12V to the source S of the transistor Q4. On the other hand, before the delay unit 20 delays the power good signal exceeding the predetermined time, the delay unit 20 outputs the low level control signal. Thus, the transistor Q4 is turned off, and the connection between the first switch unit 10 and the fan 40 is an off state. When the delay unit 20 delays the power good signal PW_GD exceeding the predetermined time, the delay unit 20 outputs the high control signal to gate G of the transistor Q4, and the transistor Q4 is turned on. Accordingly, the system power terminal P12V powers the fan 40, thereby making the fan 40 operate after the predetermined time.

During the operation of shutting down of the computer, the system power terminals P12V and P12V5 provide no voltage, but the standby power terminal P5V_SB provides voltage. At the same time, the power good signal PW_GD is at low level, and the transistor Q1 is turned off. The gates G of the transistor Q2 and Q3 are at high level, and the transistor Q2 and Q3 are turned on. Accordingly, the gate G of the transistor Q6 is at low level, and the transistor Q6 is turned off. The gate G of the transistor Q5 is at low level, and the transistor Q5 is turned on. The first switch unit 10 outputs the standby power P5V_SB to the source of the transistor Q4. On the other hand, before the delay unit 20 delays the power good signal exceeding the predetermined time, the delay unit 20 outputs the high level control signal, and the transistor Q4 is turned on. The standby power P5V_SB is provided to the fan 40. When the delay unit 20 delays the power good signal PW_GD exceeding the predetermined time, the delay unit 20 outputs the low control signal to the gate G of the transistor Q4, and the transistor Q4 is turned off to disconnect the fan 40 from the first switch unit 10. Accordingly, the fan 40 operates for the predetermined time after the computer shuts down.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A fan control circuit for a fan, comprising:
a first switch unit outputting a first voltage or a second voltage according to voltage level of a power good signal;
a delay unit performing delay operation on the power good signal, outputting a first control signal before the delay operation exceed a predetermined time, and outputting a second control signal after the delay operation exceed the predetermined time; and
a second switch unit controlling a connection between the first switch unit and the fan according to the first or second control signal;
wherein when the second switch unit receives the first control signal, the second switch unit is turned on, and the first switch unit is connected to the fan; when the second switch unit receives the second control signal, the second switch unit is turned off, and the first switch unit is disconnected from the fan.

2. The fan control circuit of claim 1, wherein when the power good signal is at high level, the first switch unit outputs the first voltage; when the power good signal is at low level, the first switch unit outputs the second voltage.

3. The fan control circuit of claim 2, wherein the first switch unit comprises first to third resistors and first to fifth electronic switches; a first terminal of the first electronic switch receives the power good signal, a second terminal of the first electronic switch is connected to ground, a third terminal of the first electronic switch is coupled to the second voltage through the first resistor, and coupled to first terminals of the second and third electronic switches; second terminals of the second and third electronic switches are connected to ground, a third terminal of the second electronic switch is coupled to a third voltage through the second resistor; the third terminal of the second electronic switch is coupled to a first terminal of the fourth electronic switch; a third terminal of the third electronic switch is coupled to the second voltage through the third resistor, and coupled to a first terminal of the fifth electronic switch; a second terminal of the fourth electronic switch is coupled to the first voltage, a third terminal of the fourth electronic switch is coupled to the second switch unit; a second terminal of the fifth electronic switch is coupled to the second voltage, a third terminal of the fifth electronic switch is coupled to the third terminal of the fourth electronic switch; the second terminal of the fifth electronic switch is coupled to an anode of a diode, a cathode of the diode is coupled to the third terminal of the fifth electronic switch; wherein when the first terminals of the first to fourth electronic switches are at a high level, the first to fourth electronic switch are turned on; when the first terminals of the first to fourth electronic switches are at a low level, the first to fourth electronic switches are turned off; when the first terminal of the fifth electronic switch is at a high level, the fifth electronic switch is turned off; when the first terminal of the fifth electronic switch is at a low level, the fifth electronic switch is turned on.

4. The fan control circuit of claim 3, wherein the first switch unit further comprises a fourth resistor, the first terminal of the first switch unit receives the power good signal through the fourth resistor.

5. The fan control circuit of claim 4, wherein the first switch unit further comprises first to third capacitors, the second terminal of the fourth electronic switch is connected to ground through the first capacitor, the second terminal of the fifth electronic switch is connected to ground through the second capacitor, the third terminal of the fourth electronic switch is connected to ground through the third capacitor.

6. The fan control circuit of claim 5, wherein the second switch unit comprises a sixth electronic switch, a first terminal of the sixth electronic switch receives the power good signal through the delay unit, a second terminal of the sixth electronic switch is coupled to the third terminal of the fourth electronic switch, a third terminal of the sixth electronic switch is coupled to the fan; wherein when the first terminal of the sixth electronic switch is at high level, the sixth electronic switch is turned on; when the first terminal of the sixth electronic switch is at low level, the sixth electronic switch is turned off.

7. The fan control circuit of claim 6, wherein the first to fourth and sixth electronic switches are n-channel metallic oxide semiconductor field effect transistors (NMOSFETs), wherein the first terminals, the second terminals, and the third terminals of the first to fourth and sixth electronic switches are gates, sources, and drains of the NMOSFETs.

8. The fan control circuit of claim 6, wherein the fifth electronic switch is a p-channel metallic oxide semiconductor field effect transistor (PMOSFET), wherein the first terminal, the second terminal, and the third terminal of the fifth electronic switch are a gate, a source, and a drain of the PMOSFET.
